(19) United States
(12) Patent Application Publication
(10) Pub. No.: US 2007/0104286 A1
(43) Pub. Date: May 10, 2007

(54) Equipment and method for MIMO SC-FED communication system

(76) Inventors: Juinn-Horng Deng, Plngjhen City (TW); Jeng-Kuang Hwang, Jhongli City (TW)

Correspondence Address: J.C. Patents, Inc., Suite 250, 4 Venture, Irvine, CA, 92618, US

(21) Appl. No.: 11/270,225

(22) Filed: Nov. 8, 2005

(51) Int. Cl. H04L 1/02; H04K 1/10

(52) U.S. Cl. 375/267; 375/260

(57) ABSTRACT

Equipment for a MIMO differential SC-FED communication system that includes a transmitter and a receiver is provided. The transmitter has a differential block encoder module for receiving a plurality of data block pairs and performing a circular convolution operation on the data blocks to produce a plurality of coded data blocks in a space-time block coding (STBC) unit. The STBC unit will perform a space-time block encoding process on the output from the differential block encoder module to obtain a plurality of transmitting data blocks. A plurality of frame generators receives the respective transmitting data blocks and adds a cyclic prefix to the corresponding transmitting data blocks to generate a plurality of block frames. Then, the frame generators send the block frames to the receiver of the present invention via a corresponding transmitting antenna.

### BACKGROUND OF THE INVENTION

1. Field of the Invention

The present invention relates to an equipment and method for a multi-input/multi-output (MIMO) single carrier frequency encoding/decoding (SC-FED) communication system. More particularly, the present invention relates to a MIMO SC-FED communication system suitable for a selective frequency attenuation channel.

2. Description of the Related Art

Among the variety of communication methods currently in use, single carrier and multiple carrier modulation is quite a reliable technique. In these two techniques, a channel distortion resulting from multi-path transmission can easily be equalized through a fast Fourier transform and its inverse transformation in the frequency domain.

Looking from another perspective, the development of the space time block coding (STBC) and the multi-input/multi-output (MIMO) system can effective resist signal attenuation under a variety of different transmission and/or reception schemes. For a frequency bandwidth with frequency selected attenuation channel, a different MIMO orthogonal frequency division multiplexing (OFDM) system is usually selected. However, this technique requires the receiving end to have a near perfect computational estimation of the channel so that the system can synchronize with decoding and other management decisions.

When the conditions of the channel change slowly, the transmission end facilitates the receiving end to obtain an accurate estimation of the channel conditions by providing a series of pilot sequences. Yet, in an environment where the channel conditions change rapidly, the job of obtaining an accurate estimation of the channel conditions is very difficult.

### SUMMARY OF THE INVENTION

Accordingly, at least one objective of the present invention is to provide a multi-input/multi-output (MIMO) differential single carrier frequency encoding/decoding (SC-FED) communication system and a method suitable for working under a communication environment whose channel attenuation conditions change very rapidly.

To achieve these and other advantages and in accordance with the purpose of the invention, as embodied and broadly described herein, the invention provides a MIMO differential SC-FED communication system having a transmitter and a receiver. The transmitter has a differential block encoder module for receiving a plurality of data block pairs and performing a circular convolution operation on the data blocks to obtain a plurality of coded data blocks in a space-time block coding (STBC) unit. The STBC unit will perform a space-time block encoding process on the output from the differential block encoder module to produce a plurality of transmitting data blocks. A plurality of frame generators receives the respective transmitting data blocks and adds a cyclic prefix to the corresponding transmitting data blocks to generate a plurality of block frames. Then, the frame generators send the block frames to the receiver of the present invention via a corresponding transmitting antenna.

In the embodiment of the present invention, the receiver includes a receiving antenna unit for receiving the block frames produced by the transmitter. Furthermore, the receiving antenna unit will also transmit the received block frames to a computational module. The computational module performs a divergent Fourier transform (DFT) and a conjugation of the block frames and then outputs the block frames to a decoding module. Thus, the decoding module can perform a complex conjugate transformation or a matrix inversion operation of the previous output from the computational module and then multiply with the current output from the computational module. Thereafter, a fast Fourier transform inversion operation is performed. In addition, the receiver further includes a decision unit coupled to the decoding unit for converting the output from the decoding unit back to the original data block.

From another perspective, the present invention also provides a MIMO differential SC-FED communicating method suitable for a frequency selected attenuation channel. The communicating method includes the following steps. First, a plurality of data block pairs is received. Then, a convolution operation is performed on these data blocks to obtain a plurality of encoded data blocks. Thereafter, a space-time block encoding process is performed on these encoded data blocks to obtain a plurality of transmitting data blocks. After that, a cyclic prefix is added to each transmitting data block. Lastly, a block frame is produced and transmitted.

In the embodiment of the present invention, a convolution operation on the coded data blocks in a previous production and the newly received data block is carried out to obtain the newest coded data block.

In addition, the present invention further include receiving the aforesaid block frames to generate a plurality of received sample blocks. Then, a divergent Fourier transform computation of these received sample blocks is carried out to obtain a plurality of Fourier transformation matrices. Thereafter, a diagonalization of each Fourier transform matrix is performed to obtain a receiving signal matrix. After that, a complex conjugate transformation or a matrix inversion operation on the previously received signal matrix is carried out and then multiplied by the currently received signal matrix to obtain a data block matrix. Finally, an inverse Fourier transform of the data block matrix is performed to obtain the original data blocks.

Because there is no need to perform a channel estimation at the transmitting end and the receiving end in the present invention, the present invention is suitable for a communication environment whose channel attenuation conditions change rapidly.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing the circuit structure of a transmitter according to one preferred embodiment of the present invention.

FIG. 2 is a block diagram showing the circuit structure of a receiver according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

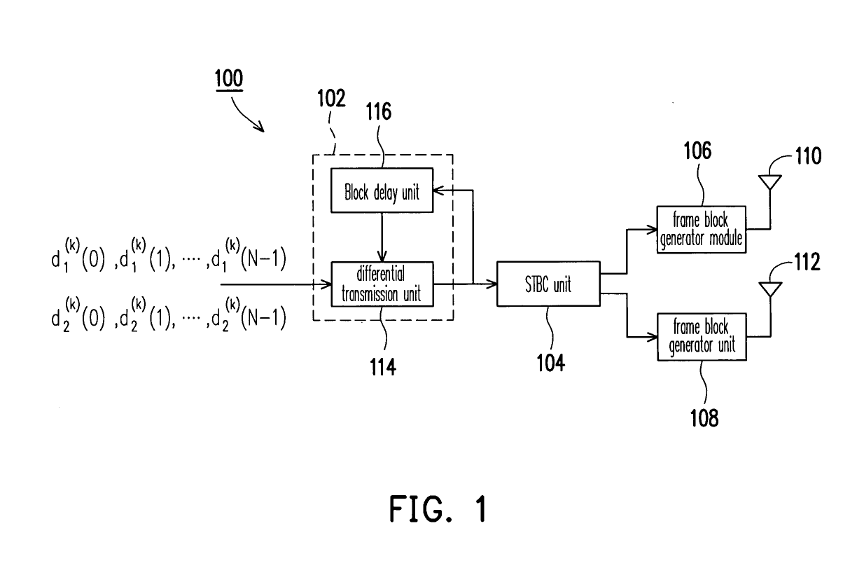

FIG. 1 is a block diagram showing the circuit structure of a transmitter according to one preferred embodiment of the present invention. The transmitter is suitable for a MIMO differential SC-FED communication system. As shown in FIG. 1, the transmitter 100 includes a differential block encoder module 102. The output of the transmitter 100 is coupled to a space-time block coding (STBC) unit 104. The outputs of the STBC unit 104 are coupled to a pair of transmitting antenna units 110 and 112 through block frame generator modules 106 and 108 respectively.

The differential block encoding module 102 can include a differential transmission unit 114 and a block delay unit 116. The differential transmission unit 114 is used for receiving N pairs of data blocks, where N is a positive integer. For example, in the d₁^{(k)}(0) to d₁^{(k)}(N−1) and d₂^{(k)}(0) to d₂^{(k)}(N−1), the upper label k represents the k^{th} block space with k equal to 0, 2, 4. . . and so on. The lower label represents the index value, for example, the data block with the lower label 1 is transmitted through the transmitting antenna unit 110. On the contrary, the data block with the lower label 2 is transmitted through the transmitting antenna unit 112.

When the differential transmission unit 114 receives the data blocks, the data blocks will be encoded to produce a plurality of coded data blocks xᵢ^{(k)}. Similarly, the upper label k in the coded data block xᵢ^{(k)} represents the data space value and the lower label i is the index value of the antenna. When the differential transmission unit 114 generates a plurality of coded data blocks xᵢ^{(k)}, the encoded data blocks will be transmitted to the STBC unit 104 and the data block delay unit 116. The data block delay unit 116 will be fed back to the differential transmission unit 114 after the coded data block xᵢ^{(k)} from the differential transmission unit 114 has undergone a delay so that a newer coded data block xᵢ^{(k)} is produced.

In the present invention, the differential transmission unit 114 performs a circular convolution operation on the previously obtained coded data block xᵢ^{(k)} and the currently acquired data block to produce the newest coded data block xᵢ^{(k)}. Thus, the method of generating the coded data block xᵢ^{(k)} can be represented by the following matrix formula:

$$[ \begin{matrix}{x}_{1}^{( k )} \\ {x}_{2}^{( k )}\end{matrix} ] = [ \begin{matrix}( {x}_{1}^{( k - 2 )} * {d}_{1}^{( k )} ) + ( {x}_{1}^{( k - 1 )} * {d}_{2}^{( k )} ) \\ ( {x}_{2}^{( k - 2 )} * {d}_{1}^{( k )} ) + ( {x}_{2}^{( k - 1 )} * {d}_{2}^{( k )} )\end{matrix} ]$$

where
   X₁^{(k-2)}=[X₁^{(k-2)}(0)X₁^{(k-2)}(1) . . . X₁^{(k-2)}(N−1)]^{T}
   X₂^{(k-2)}=[X₂^{(k-2)}(0)X₂^{(k-2)}(1) . . . X₂^{(k-2)}(N−1) ]^{T}
   X₁^{(k-1)}=[−X₂^{(k-2)*}(0)−X₂^{(k-2)*}(N−1) . . . X₂^{(k-2)*}(1)]^{T}
   X₂^{(k-1)}=[X₁^{(k-2)*}(0)X₁^{(k-2)*}(N−1) . . . X₁^{(k-2)*}(1)]^{T}
and the symbol * represents a circular convolution operation.

Thereafter, the differential transmission unit 114 will transmit the output to the STBC unit 104 to perform a space-time block encoding process. After the STBC unit 104 has encoded the output from the differential transmission unit 114, a plurality of transmitting data blocks is produced. These transmission data blocks will be delivered to a corresponding frame generator module (106 or 108). The frame generator module 106 and 108 will add a cyclic prefix to the output from the STBC unit 104 to produce frame blocks and then transmit the frame blocks to the receiver of the communication system in the present invention through the corresponding transmitting antenna unit (110 or 112).

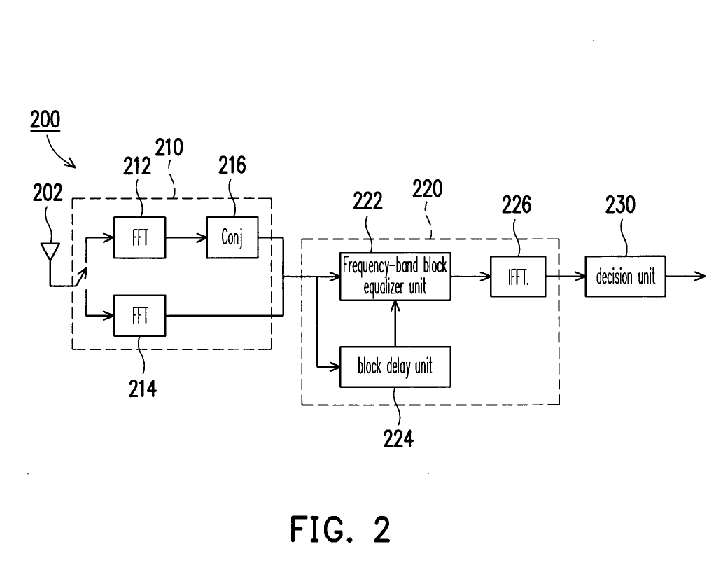

FIG. 2 is a block diagram showing the circuit structure of a receiver according to one preferred embodiment of the present invention. Similarly, the receiver is suitable for the MIMO differential SC-FED communication system of the present invention. As shown in FIG. 2, the receiver 200 includes a receiving antenna unit 202 that couples to a computational module 210. The output from the computational module 210 is transmitted to a decoding module 220 and the output of the decoding module 220 is coupled to a decision unit 230.

Although the channel used for transmitting the frame blocks operates as a linear convolution operation, the operation will perform as a circular convolution operation due to the action of the cyclic prefix. After the receiving antenna unit 202 has received the frame blocks transmitted from the transmitter shown in FIG. 1, a plurality of data sample blocks is generated. Because the number of transmitting antenna unit is 2 while the number of receiving antenna unit is just 1, the data sample blocks can be represented by the following formula:
y^{(j)}=H₁^{(j)}x₁^{(j)}+H₂^{(j)}x₂^{(j)}+n^{(j)}
where the upper label j represents the j^{th} received frame block and is a positive integer. H₁^{(j)} and H₂^{(j)}, due to the cyclic prefix, is an N×N circular matrix. In addition, the term n^{(j)} is a noise-generated vector.

Because H (disregarding the superscript and the underscript) is a circular matrix, an Eigen-decomposition of the matrix can be represented by the following formula:
H=Q^{H}ΛQ
where (.)^{H} represents a complex conjugate transform matrix and Q is a standardized divergent Fourier transform matrix, and Λ is a diagonalized Eigen-value matrix.

As shown in FIG. 2, the computational module 210 further includes fast Fourier transform (FFT) units 212 and 214 and a conjugation computation unit 216. After the receiving antenna unit 202 has generated the data sample blocks, the fast Fourier transform units 212 and 214 will perform a divergent Fourier transform of the output from the receiving antenna unit 202, which can be represented by the following formula:
\tilde{y}^{(j)}=Qy^{(j)}=Λ₁^{(j)}\tilde{x}₁^{(j)}+Λ₂^{(j)}\tilde{x}₂^{(j)}+ñ^{(j)} (1)
where \tilde{x}ᵢ^{(j)}=Qxᵢ^{(j)} and ñ^{(j)l =Qn}^{(j)}.

After the fast Fourier transform (FFT) unit 212 has performed a divergent Fourier transform on the output from the receiving antenna unit 202, the conjugation computation unit 216 will perform a conjugation operation on the output from the fast Fourier transform (FFT) unit 212. Through this operation, the output from the computation module 210 can be represented by the following formulae:
\tilde{Y}^{(k)}=Λ₁^{(k)}\tilde{x}₁^{(k)}+Λ₂^{(k)}\tilde{x}₂^{(k)}+\tilde{n}(k)
\tilde{Y}^{(k)*}=Λ₁^{(k)H}\tilde{x}₁^{(k)*}+Λ₂^{(k)H}\tilde{x}₂^{(k)*}+ñ^{(k)*}
\tilde{Y}^{(k+1)*}=−Λ₁^{(k+1)}^{^{H}}\tilde{x}₂^{(k)}+Λ₂^{(k+1)H}\tilde{x}₁^{(k)}+ñ^{(k+1)*}
\tilde{Y}^{(k+1)}=−Λ₁^{(k+1)}\tilde{x}₂^{(k)*}+Λ₂^{(k+1)}\tilde{x}₁^{(k)*}+ñ^{(k+1)} (2)
In addition, assume the two consecutive blocks in the channel are fixed, that is,
Hᵢ^{(k+1)}=H₁^{(k)}=Hᵢ
Λᵢ^{(k+1)=Λ}ᵢ^{(k)}=Λᵢ (3)
By combining the formula (2) and the formula (3), the following received signal matrix is obtained:

$$\begin{matrix} {{Y}^{ \_}}^{( k )} = [ \begin{matrix}diag ( {\tilde{Y}}^{( k )} ) & diag ( {\tilde{Y}}^{( k + 1 )} ) \\ diag ( {\tilde{Y}}^{{( k + 1 )}^{*}} ) & - diag ( {\tilde{Y}}_{1}^{{( k )}^{*}} )\end{matrix} ] \\ = [ \begin{matrix}{Λ}_{1} & {Λ}_{2} \\ {Λ}_{2}^{H} - & {Λ}_{1}^{H}\end{matrix} ] [ \begin{matrix}diag ( {\tilde{x}}_{1}^{( k )} ) & - diag ( {\tilde{x}}_{2}^{{( k )}^{*}} ) \\ diag ( {\tilde{x}}_{2}^{( k )} ) & diag ( {\tilde{x}}_{1}^{{( k )}^{*}} )\end{matrix} ] + {\overline{N}}^{( k )}\end{matrix} \qquad ( 4 )$$

Similarly, according to formula (1), the next batch of received signal matrix can be represented by the following formula:

$${\overline{Y}}^{( k + 2 )} = [ \begin{matrix}{\tilde{Y}}^{( k + 2 )} \\ {\tilde{Y}}^{{( k + 3 )}^{*}}\end{matrix} ] = [ \begin{matrix}{Λ}_{1} & {Λ}_{2} \\ {Λ}_{2}^{H} & - {Λ}_{1}^{H}\end{matrix} ] [ \begin{matrix}{\tilde{x}}_{1}^{( k + 2 )} \\ {\tilde{x}}_{2}^{( k + 2 )}\end{matrix} ] \\ where \\ \begin{matrix}[ \begin{matrix}{\tilde{x}}_{1}^{( k + 2 )} \\ {\tilde{x}}_{2}^{( k + 2 )}\end{matrix} ] = [ \begin{matrix}Q & 0 \\ 0 & Q\end{matrix} ] [ \begin{matrix}{x}_{ 1}^{( k + 2 )} \\ {x}_{ 2}^{( k + 2 )}\end{matrix} ] \\ = [ \begin{matrix}diag \{ Q ( {x}_{ 1}^{( k )} * {d}_{ 1}^{( k + 2 )} ) \} + diag \{ Q ( {x}_{ 1}^{( k + 1 )} * {d}_{ 2}^{( k + 2 )} ) \} \\ diag \{ Q ( {x}_{ 2}^{( k )} * {d}_{ 1}^{( k + 2 )} ) \} + diag \{ Q ( {x}_{ 2}^{( k + 1 )} * {d}_{ 2}^{( k + 2 )} ) \}\end{matrix} ] \\ = [ \begin{matrix}diag ( { \tilde{x}}_{1}^{( k )} ) & - diag ( { \tilde{x}}_{2}^{ {( k )}^{*}} ) \\ diag ( { \tilde{x}}_{2}^{( k )} ) & diag ( { \tilde{x}}_{1}^{ {( k )}^{*}} )\end{matrix} ] [ \begin{matrix} { \tilde{d}}_{1}^{( k + 2 )} \\ { \tilde{d}}_{2}^{( k + 2 )}\end{matrix} ]\end{matrix} \qquad ( 5 )$$

Because of the circular convolution characteristics of the divergent Fourier transform, \tilde{d}ᵢ^{(k+2)}=Qdᵢ^{(k+2)} and formula (5) can be re-written as:

$$\begin{matrix}{{Y}^{ \_}}^{( k + 2 )} = [ \begin{matrix}{\tilde{Y}}^{( k + 2 )} \\ {\tilde{Y}}^{ {( k + 3 )}^{*}}\end{matrix} ] \\ = [ \begin{matrix}{Λ}_{ 1} & {Λ}_{ 2} \\ {Λ}_{ 2}^{ H} & - {Λ}_{ 1}^{ H}\end{matrix} ] [ \begin{matrix}diag ( { \tilde{x}}_{1}^{( k )} ) & - diag ( { \tilde{x}}_{2}^{ {( k )}^{*}} ) \\ diag ( { \tilde{x}}_{2}^{( k )} & diag ( { \tilde{x}}_{1}^{ {( k )}^{*}} )\end{matrix} ] \\ [ \begin{matrix}{\tilde{d}}_{1}^{( k + 2 )} \\ {\tilde{d}}_{2}^{( k + 2 )}\end{matrix} ] + {{N}^{ \_}}^{( k + 2 )}\end{matrix}$$

When the computational module 210 transmits the output to the decoding module 220, the frequency-band block equalizer unit 222 and the block delay unit 224 will simultaneously receive the output from the computational module 210. The block delay unit 224 will transmit the output from the computational module 210 to the frequency-band block equalizer unit 222 after a delay period. The frequency-band block equalizer unit 222 will perform a complex conjugate transform on the previous batch of received signal matrix and then multiply with the current received signal matrix. The process may be represented using the following formula:

$$[ \begin{matrix}{\overline{d}}_{1}^{( k + 2 )} \\ {\overline{d}}_{2}^{( k + 2 )}\end{matrix} ] = {\overline{Y}}^{{( k )}^{H}} {\overline{Y}}^{( k + 2 )} = [ \begin{matrix}\tilde{Λ} & 0 \\ 0 & \tilde{Λ}\end{matrix} ] [ \begin{matrix}\tilde{X} & 0 \\ 0 & \tilde{X}\end{matrix} ] [ \begin{matrix}{\tilde{d}}_{1}^{( k + 2 )} \\ {\tilde{d}}_{2}^{( k + 2 )}\end{matrix} ] + {\overline{n}}^{( k + 2 )}$$

Here, \tilde{Λ}=|Λ₁|²+|Λ₂² and \tilde{X}=diag(|\tilde{x}₁^{(k)}|² +|\tilde{x}₂^{(k)}|² ).

In some other embodiment, the frequency-band block equalizer unit 222 performs an inverse matrix transform operation on the previous batch of received signal matrix and then multiplies with the current received signal matrix, that is,

$$[ \begin{matrix}{\overline{d}}_{1}^{( k + 2 )} \\ {\overline{d}}_{2}^{( k + 2 )}\end{matrix} ] = {\overline{Y}}^{{( k )}^{- 1}} {\overline{Y}}^{( k + 2 )} = [ \begin{matrix}I & 0 \\ 0 & I\end{matrix} ] [ \begin{matrix}{\tilde{d}}_{1}^{( k + 2 )} \\ {\tilde{d}}_{2}^{( k + 2 )}\end{matrix} ] + {\overline{n}}^{( k + 2 )}$$

Lastly, the output from the frequency-band block equalizer unit 222 is transmitted to an inverse fast Fourier transform (IFFT) unit 226 to perform a Fourier transform inversion operation. Then, the result is output to the decision unit 230. Thus, the decision unit 230 will convert back to the original data block according to the output from the decoding module 220.

Although the receiver 200 in FIG. 2 has a single receiving antenna unit 202, this does not limit the present invention as such. Anyone familiar with the technique may implement the required number of receiving antenna units accordingly. Furthermore, another receiving unit can easily replicate the aforesaid receiver. Hence, the present invention can obtain more multifarious gains.

In summary, the advantages of the present invention includes at least the following:
1. The present invention deploys the signal carrier frequency-band equalizing technique and is applicable to a multi-path channel with multiple frequency selection.
2. There is no need to perform channel estimation in either the transmitter end or the receiver end. Hence, the present invention is particularly adapted to a communication environment where the frequency attenuation conditions change rapidly.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multi-input/multi-output (MIMO) differential single carrier frequency encoding/decoding (SC-FED) communication system having a transmitter and a receiver, the transmitter comprising:
a differential block-encoding module for receiving a plurality of data block pairs and performing a circular convolution operation on the data blocks to obtain a plurality of coded data blocks:
a space-time block encoding unit for performing a space-time block encoding on the output from the differential block encoding module to generate a plurality of transmitting data blocks;
a plurality of frame generator modules that corresponds to the transmitting data blocks and a cyclic prefix added to a corresponding transmitting data block to generate a plurality of frame blocks; and
a plurality of transmitting antenna units that couples with a corresponding space-time block−encoding unit, wherein each frame generator module transmits the self-generated frame blocks to the receiver through a corresponding transmitting antenna unit.

2. The communication system of claim 1, wherein the differential block encoding module further comprises:
a differential transmission unit for receiving the data blocks to generate the coded data blocks; and
a first block delay unit for feeding back the output from the differential transmission unit to the differential transmission unit,
wherein the differential transmission unit performs a circular convolution operation on the previously generated coded data block and the newly received data block to produce a newest coded data block and then outputs the newest coded data block to the first block delay unit and the space-time block encoding unit.

3. The communication system of claim 1, wherein the receiver further includes:
a receiving antenna unit for receiving the frame blocks;
a computational module for performing a divergent Fourier transform and a conjugate operation on the frame blocks;
a decoding module for receiving the output from the computational module so that either a complex conjugate transform or a matrix inversion operation is carried out on the previous output of the computational module and then multiplied with the current output of the computational module to perform a fast Fourier transform inversion operation; and
a decision unit coupled to the decoding unit for converting the output from the decoding unit to the original data block.

4. The communication system of claim 3, wherein the computational module further includes:
a first fast Fourier operational unit coupled to the receiving antenna unit for performing a divergent Fourier transform on the frame blocks received from the receiving antenna unit;
a conjugation operation unit for performing a conjugation operation on the output from the first fast Fourier operation unit and outputting the result to the decoding module; and
a second fast Fourier operation unit coupled to the receiving antenna unit for performing a divergent Fourier transform on the frame blocks received from the receiving antenna unit and outputting the result to the decoding module.

5. The communication system of claim 3, wherein the decoding module comprises:
a second block delay unit for receiving the output from the computational module;
a frequency-band block equalizer unit for receiving the output from the computational module and the second block delay unit and performing a complex conjugate transform or a matrix inversion operation on the previous output of the computational module and then multiplying with the current output from the computational module; and
an inverse Fourier transform computational unit for performing a Fourier transform inversion operation on the output from the frequency-band block equalizer unit.

6. An multi-input/multi-output (MIMO) differential single carrier frequency encoding/decoding (SC-FED) communicating method suitable for operating a frequency selected attenuation channel, comprising the steps of:
receiving a plurality of data block pairs;
performing a circular convolution operation on the data blocks to obtain a plurality of coded data blocks;
performing a space-time block encoding process on the coded data blocks to obtain a plurality of transmitting data blocks;
adding a cyclic prefix to each transmitting data block to produce a frame block; and
transmitting the frame blocks through space.

7. The communicating method of claim 6, wherein the step for generating the coded data blocks includes performing a circular convolution operation on the previously generated coded data block and the newly received data block to obtain the newest coded data block.

8. The communicating method of claim 6, wherein the communicating method further includes:
receiving the frame blocks to generate a plurality of received sample blocks;
performing a divergent Fourier transform on the received sample blocks to obtain a plurality of Fourier transform matrices:
performing a diagonalization operation on each of the Fourier transform matrices to obtain a received signal matrix;
performing a complex conjugate operation on the previously received signal matrix and then multiplying with the currently received signal matrix to obtain a data block matrix; and
performing an inverse Fourier transform on the data block matrix to convert the data block to the original data block.

9. The communicating method of claim 6, wherein the communicating method further includes:
receiving the frame blocks to generate a plurality of received sample blocks;
performing a divergent Fourier transform operation on the received sample blocks to obtain a plurality of Fourier transform matrices;
performing a diagonalization operation on each of the Fourier transform matrix to obtain a received signal matrix;
performing an inverse Fourier transform operation on the previously obtained receiving signal matrix to obtain a data block matrix; and
performing an inverse Fourier transform on the data block matrix to convert the data blocks into the original data blocks.
